(19) United States
(12) Patent Application Publication
(10) Pub. No.: US 2014/0204518 A1
(43) Pub. Date: Jul. 24, 2014

(54) BASE OF ELECTRONIC DEVICE

(71) Applicant: HON HAI PRECISION INDUSTRY CO., LTD., New Taipei (TW)

(72) Inventor: CHIA-HUEI LIN, New Taipei (TW)

(73) Assignee: HON HAI PRECISION INDUSTRY CO., LTD., New Taipei (TW)

(21) Appl. No.: 14/133,932

(22) Filed: Dec. 19, 2013

(30) Foreign Application Priority Data
Jan. 21, 2013 (CN) 2013100210645

(51) Int. Cl. G06F 1/16

(52) U.S. Cl. CPC G06F 1/1669
USPC 361/679.12

(57) ABSTRACT

A base of an electronic apparatus includes a station and a keyboard. The station includes a first side and a second side. The display apparatus is pivotally mounted on the first side. The keyboard is detachably mounted on the first side of station. The station rotates with respect to the display apparatus between a first position and a second position. In the first position, the second side of the station is placed on a supporting surface, and an obtuse angle is defined between the first side and the display apparatus. In the second position, the first side of the station is placed on the supporting surface, an acute angle is defined between the first side and the display apparatus, and the keyboard is detached from the station, placed on the supporting surface and located at a front portion of the display apparatus.

### BACKGROUND

1. Technical Field

The disclosure generally relates to bases of electronic devices, and more particularly to a base of an electronic device which has a detachable keyboard.

2. Description of Related Art

As input technologies are being developed, the touch screens are used widely. For example, notebook computers are equipped with the touch screens for inputting information. Further, the base of the notebook computer can rotate 295 degrees or 320 degrees about the touch screen of the notebook computer to support the touch screen in inclined positions. However, when the touch screen is in inclined positions, the keyboard on the base cannot be used.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of a base of an electronic device.

FIG. 2 is block view of a keyboard of the base of FIG. 1.

FIG. 3 is an assembled view of the base of FIG. 1.

FIG. 4 is another assembled view of the base of FIG. 1.

FIG. 5 is an exploded, isometric view of another embodiment of a base of an electronic device.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

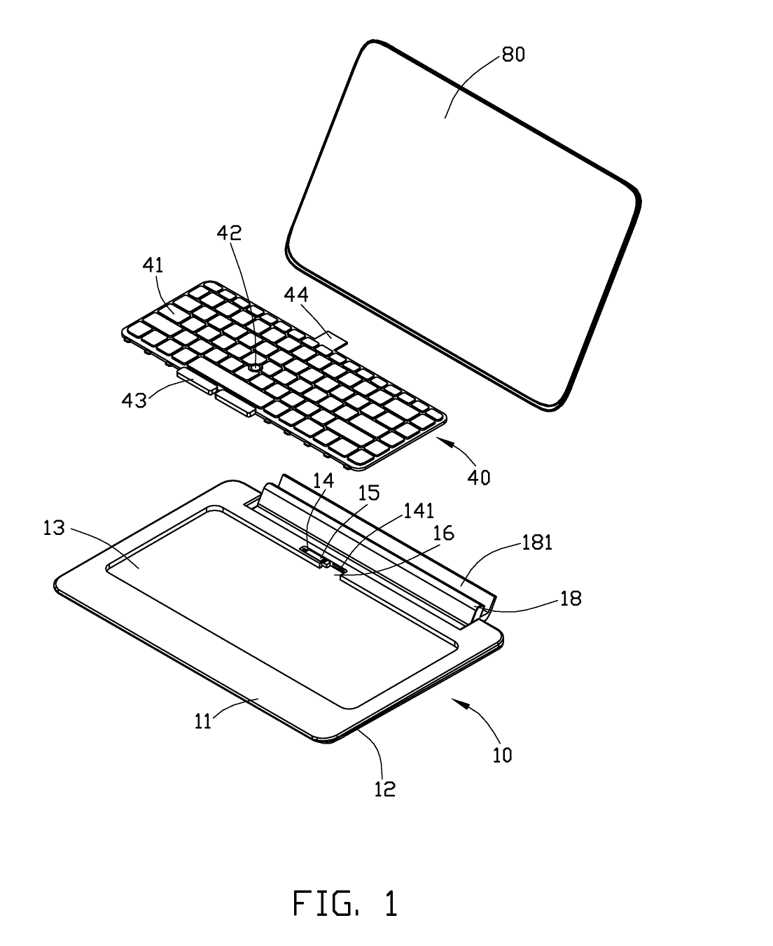

FIG. 1 shows one embodiment of a base of an electronic device. The base includes a station 10 and a keyboard 40. In one embodiment, the station 10 can support a display apparatus 80. The display apparatus 80 can be a touch screen of a notebook computer or a tablet computer.

The station 10 includes a first side 11 and a second side 12 opposite to the first side 11. A center portion of first side 11 is sunk to define a receiving room 13. The receiving room 13 can receive the keyboard 40 mounted therein. The station 10 defines a slide groove 14 adjacent the receiving room 13. A station connector 141 is mounted in the slide groove 14. A slide block 15 slides in the slide groove 14. A cutout 16 is defined between the slide groove 14 and the receiving room 13 to communicate the slide groove 14 with the receiving room 13. The cutout 16 is aligned to the station connector 141. A supporter 18 is pivotally mounted on a front portion of the station 10. The supporter 18 defines a receiving groove 181.

The keyboard 40 includes a plurality of keys 41, a cursor ball 42, and two buttons 43. The cursor ball 42 is located among the plurality of keys 41. The two buttons 43 are located on a rear portion of the keyboard 40. The two buttons 43 have a same function of left and right keys of a mouse. A keyboard connector 44 is located on a front portion of the keyboard 40.

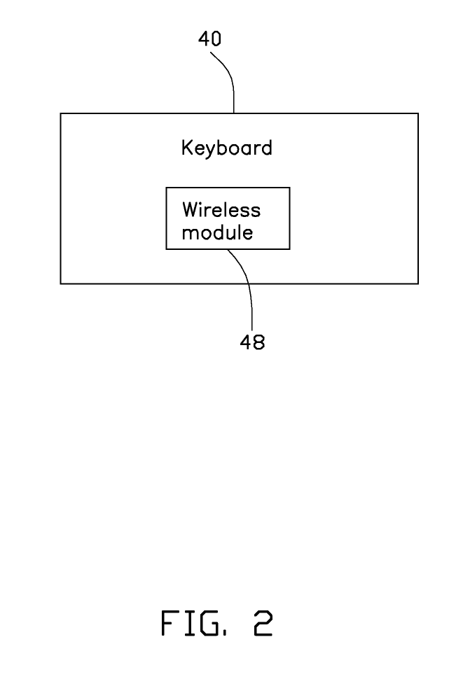

FIG. 2 shows that the keyboard 40 is a wireless keyboard which includes a wireless module 48. The wireless module 48 is a infrared module, a BLUETOOTH module or a WIFI module. The keyboard 40 can communicate with the display apparatus 80 via the wireless module 48.

A bottom edge of the display apparatus 80 can be placed in the receiving groove 181 of the supporter 18.

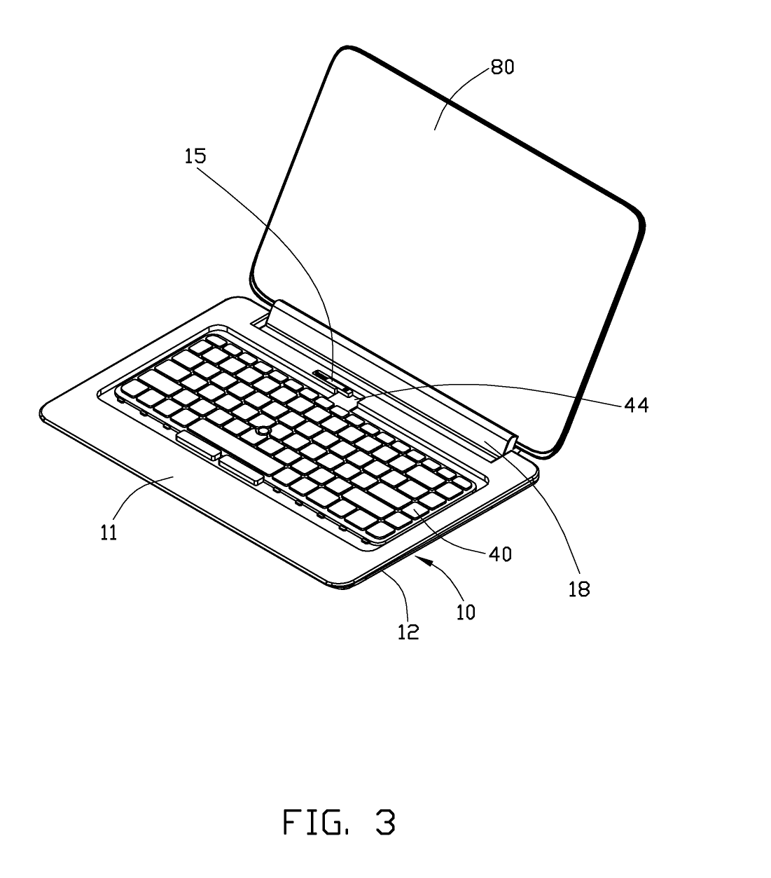

FIG. 3 shows that the second side of the station 10 is located on a supporting surface. The keyboard 40 is placed in the receiving room 13 of the station 10. The keyboard connector 44 extends through the cutout 16 to connect to the station connector 141. Then, the slide block 15 slides in the cutout 16 to press the keyboard connector 44. Therefore, the station 10 charges the keyboard 40 via the station connector 141 and the keyboard connector 44. At last, the bottom edge of the display apparatus 80 is placed in the receiving groove 181 of the supporter 18.

FIG. 3 shows that the station 10 is located in a first supporting position. In the first supporting position, the second side of the station 10 is placed on the supporting surface. An obtuse angle is defined between the first side 11 of the station 10 and the display apparatus 80. The keyboard 40 communicates with the display apparatus 80 via the wireless module 48. The station 10 charges the keyboard 40.

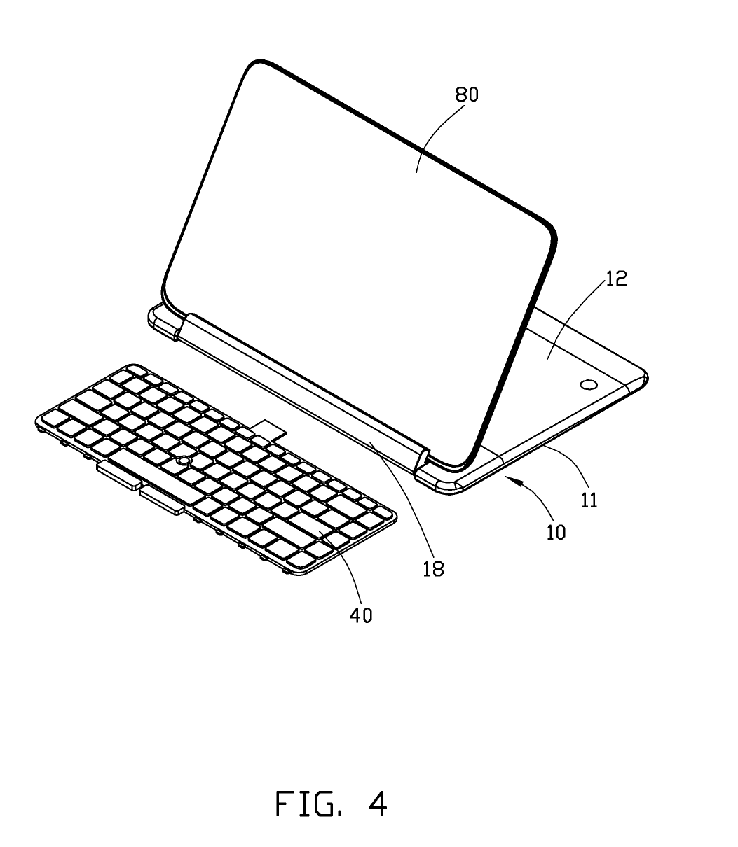

FIG. 4 shows that the station 10 is located in a second supporting position. In the second supporting position, the first side 11 of the station 10 is placed on the supporting surface. An acute angle is defined between the first side 11 and the display apparatus 80. The keyboard 40 is detached from the station 10. The keyboard 40 is placed on the supporting surface and located at a front portion of the display apparatus 80. The keyboard 40 communicates with the display apparatus 80 via the wireless module 48.

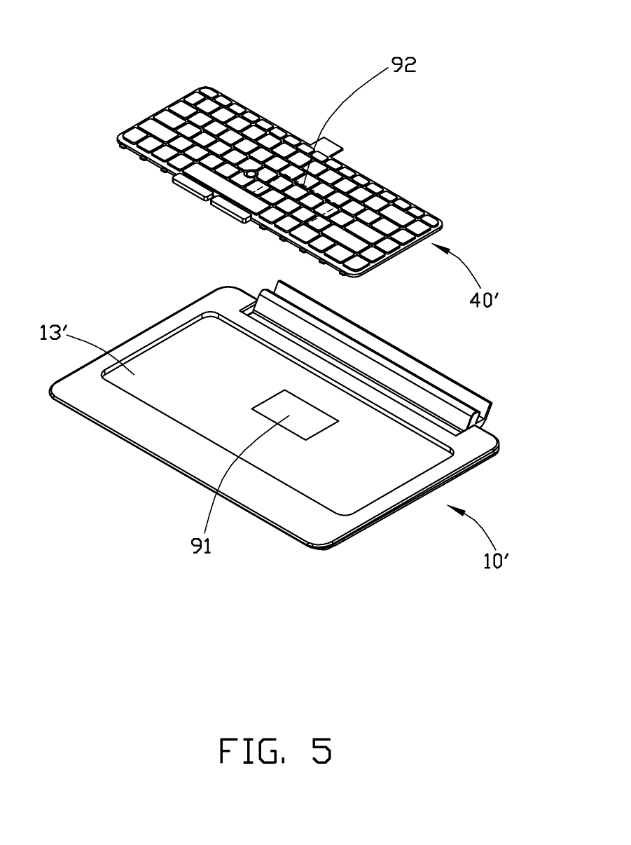

FIG. 5 shows another embodiment of the base, which includes a station 10′ and a keyboard 40′. A center portion of the station 10′ is sunk to define a receiving room 13′. A first magnet 91 is located in the receiving room 13′. A bottom portion of the keyboard 40′ is mounted with a second magnet 92. The first magnet 91 attracts the second magnet 92 to mount the keyboard 40′ in the base 10′.

It is to be understood, however, that even though numerous characteristics and advantages of the embodiments have been set forth in the foregoing description, together with details of the structure and functions of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A base of an electronic apparatus, comprising:
a station comprising a first side and a second side opposite to the first side, a display apparatus pivotally mounted on the first side of the station; and
a keyboard detachably mounted on the first side of the station;
wherein the station is configured to rotate relative to the display apparatus between a first position and a second position; when the station is in the first position, the keyboard is mounted on the first side, the second side of the station is configured to be placed on a supporting surface, and an obtuse angle is defined between the first side and the display apparatus; and when the station is in the second position, the first side of the station is configured to be placed on the supporting surface, an acute angle is defined between the first side and the display apparatus, and the keyboard is detachable from the station.

2. The base of claim 1, wherein the station comprises a station connector, the keyboard comprises a keyboard connector, the keyboard connector is configured to connect the station connector to charge the keyboard in the first position.

3. The base of claim 2, wherein the station defines a slide way, a slide block slides in the slide way, the station connector is located in the slide way, and the slide block is configured to press the keyboard connector when the keyboard connector is connected to the station connector.

4. The base of claim 3, wherein a cutout is defined on the station, the cutout communicates with the slide way, the station connector is aligned with the cutout, and the keyboard connector is extendable through the cutout to connect to the station connector.

5. The base of claim 4, wherein the first side defines a receiving room, and the receiving room is configured to receive the keyboard.

6. The base of claim 1, wherein the keyboard comprises a plurality of keys, a cursor ball among the plurality of keys, two buttons on a first portion of the keyboard, and a keyboard connector on a rear portion of the keyboard.

7. The base of claim 1, wherein a first magnet is mounted on the first side of the station, a second magnet is mounted on a bottom portion of the keyboard, and the first magnet is configured to absorb the second magnet to mount the keyboard on the first side of the station.

8. The base of claim 1, wherein a supporter is pivotally mounted on the station, the supporter defines a receiving groove, and a bottom edge of the display apparatus is placed in the receiving groove.

9. The base of claim 1, wherein the keyboard comprises a wireless module, and the keyboard is configured to communicate with the display apparatus via the wireless module.

10. A base of an electronic apparatus, comprising:
a station defines a receiving room;
a keyboard detachably mounted in the receiving room;
a display apparatus pivotally mounted on the station;
wherein the station is configured to rotate with respect to the display apparatus between a first position and a second position; in the first position, the station is located at a front portion of the display apparatus and the keyboard is mounted in the receiving room; in the second position, the station is located at a rear portion of the display apparatus, and the keyboard is detached from the receiving room.

11. The base of claim 10, wherein the station comprising a first side and a second side opposite to the first side, the display apparatus is pivotally mounted on the first side of the station, and the receiving room is defined in the first side.

12. The base of claim 11, wherein in the first position, the second side of the station is configured to be placed on a supporting surface, and an obtuse angle is defined between the first side and the display apparatus; in the second position, the first side of the station is configured to be placed on the sporting surface, an acute angle is defined between the first side and the display apparatus.

13. The base of claim 12, wherein the station comprises a station connector, the keyboard comprises a keyboard connector, the keyboard connector is configured to connect the station connector to charge the keyboard in the first position.

14. The base of claim 13, wherein the station defines a slide way, a slide block slides in the slide way, the station connector is located in the slide way, and the slide block is configured to press the keyboard connector when the keyboard connector is connected to the station connector.

15. The base of claim 14, wherein a cutout is defined on the station, the cutout communicates with the slide way, the station connector is aligned to the cutout, and the keyboard connector is extendable through the cutout to connect to the station connector.

16. The base of claim 10, wherein the keyboard comprises a plurality of keys, a cursor ball among the plurality of keys, two buttons on a first portion of the keyboard, and a keyboard connector on a rear portion of the keyboard.

17. The base of claim 10, wherein a first magnet is mounted in the receiving room, a second magnet is mounted on a bottom portion of the keyboard, and the first magnet is configured to absorb the second magnet to mount the keyboard in the receiving room.

18. The base of claim 10, wherein a supporter is pivotally mounted on the station, the supporter defines a receiving groove, and a bottom edge of the display apparatus is placed in the receiving groove.

19. The base of claim 10, wherein the keyboard comprises a wireless module, and the keyboard is configured to communicate with the display apparatus via the wireless module.
